(19) United States
(12) Patent Application Publication
(10) Pub. No.: US 2005/0151952 A1
(43) Pub. Date: Jul. 14, 2005

(54) Photolithography system with variable shutter and method of using the same

(76) Inventors: Hung-Chi Wang, Taipei City (TW); Chung-Ming Kuo, Tai-Nan City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,363

(22) Filed: Jul. 4, 2004

(30) Foreign Application Priority Data
Jan. 8, 2004 (TW) 093100411

(51) Int. Cl. G03B 27/72

(52) U.S. Cl. 355/71

(57) ABSTRACT

A photolithography system applied to the semiconductor process includes a light source, a shutter set, and a lens set. The shutter set has a variable opening area. The shutter set can include a plurality of triple-blade shutters and utilizes step motors to adjust the relative positions of the triple-blade shutters. The opening area is adjusted in accordance with the intensity of the light source or the required dose.

### BACKGROUND OF INVENTION

1. Field of the Invention

The invention relates to a photolithography system and a method of using the same, and more particularly, to a photolithography system that can be applied to a low-dose process and a method of using the same.

2.Description of the Prior Art

When fabricating semiconductor chips, circuit layout is accomplished by hundreds of processes, such as a thin-film process, a photolithography process, a doping process, and an etching process. When performing the photolithography process, a layer of photoresist is firstly coated on the wafer and a circuit layout on a mask is then transferred onto the photoresist by light source illumination. Material of the photoresist is chemically changed after being illuminated and a stripper is used to remove the illuminated photoresist or the unexposed photoresist from the wafer. The circuit layout corresponding to the mask is completed after transferring the pattern. When the photoresist is illuminated by a light source, the dose of the photoresist is a product of the light intensity and the time of exposure. For shortening the exposure time to improve throughput, a high power lamp is generally used.

Please refer to FIGS. 1 and 2, which are schematic diagrams of the internal elements of conventional exposure equipment 10 and the conventional triple-blade shutter 14. The exposure equipment 10 includes a lamp 12, a triple-blade shutter 14, a plurality of lens 16, a mask 18, a camera lens 20, and a plurality of reflective mirrors 24. The triple-blade shutter 14 is a rapidly rotating blade structure. When performing the exposure process, the lamp 12 generates light, the triple-blade shutter 14 controls the exposure time, the reflective mirrors 24 reflect the light, and the circuit pattern on the mask 18 is transferred to the wafer 22. When the opening area between blades of the triple-blade shutter 14 is rotated so as to align with the light-emitting path, the opening area will allow light to pass and the exposure time can be adjusted by controlling the rotating speed of the triple-blade shutter 14.

For obtaining a better throughput, a high power lamp 12 is used to shorten the exposure time in the general fabrication procedure, and the rotating speed of the triple-blade shutter 14 is also relatively accelerated. However, this method has some problems while performing a low-dose process. The maximum rotating speed of the triple-blade shutter 14 is limited, so the requirements of a low-dose process cannot be satisfied. The conventional method to solve this problem is distancing the lamp 12 or placing a filter (not shown) in the light path to reduce the light intensity. When performing different processes requiring different doses, the position of the lamp 12 is repeatedly adjusted or the filter is repeatedly inserted or removed. This conventional method not only wastes time and reduces the throughput but also lowers the accuracy and causes pollution.

### SUMMARY OF INVENTION

It is therefore a primary objective of the claimed invention to provide a photolithography system with a variable shutter and method of using the same to solve the above-mentioned problem.

The claimed invention discloses a photolithography system used for a semiconductor process. The photolithography system includes a light source, a shutter device having a variable opening area, and a lens set. The shutter device has a plurality of triple-blade shutters, and the shutter device utilizes a step motor to adjust the relative positions of the triple-blade shutters to achieve the variable opening area. The size of the variable opening area is decided in accordance with intensity of the light source or a dose required in manufacturing process.

The claimed invention further discloses a photolithography method used for a semiconductor process. The photolithography method includes providing a light source, providing a shutter device having a variable opening area, adjusting size of the variable opening area, and performing a photolithography process with the light source and the shutter device. The shutter device has a plurality of triple-blade shutters, and the shutter device utilizes a step motor to adjust the relative positions of the triple-blade shutters to achieve the variable opening area. The size of the variable opening area is decided in accordance with intensity of the light source or a dose required in manufacturing process.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of the internal elements of the exposure equipment according to the prior art.

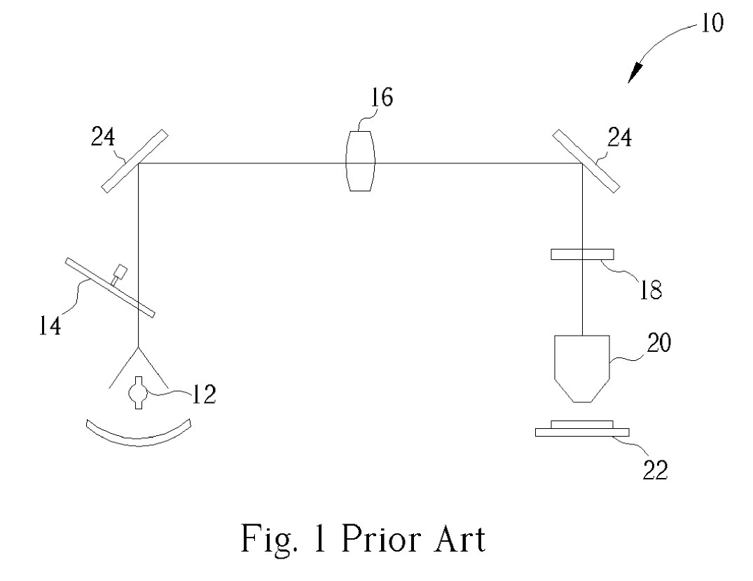

FIG. 2 is a schematic diagram of a triple-blade shutter according to the prior art.

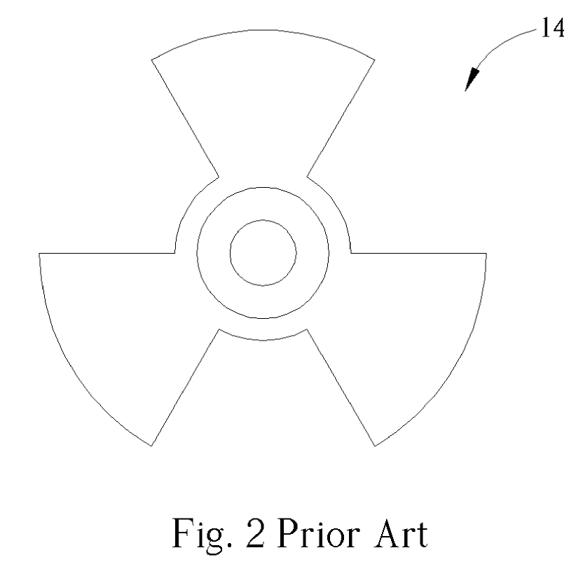

FIG. 3 is a schematic diagram of a shutter device having a variable opening area according to a preferred embodiment of the present invention.

### DETAILED DESCRIPTION

Like the prior art system 10, the photolithography system of the present invention also includes a light source and a lens set having various optical elements. However, unlike the prior art system 10, the opening area of the present invention shutter device is adjustable. The shutter device with variable opening area can change size of the opening area according to process requirements, so this kind of shutter device can be used for both high-dose and low-dose processes without repeatedly adjusting position of the lamp or replacing the filter. When performing the low-dose process, the opening area of the claimed shutter device can be adjusted smaller to allow less light to pass, and the same rotating speed of the shutter device can accomplish the low-dose process.

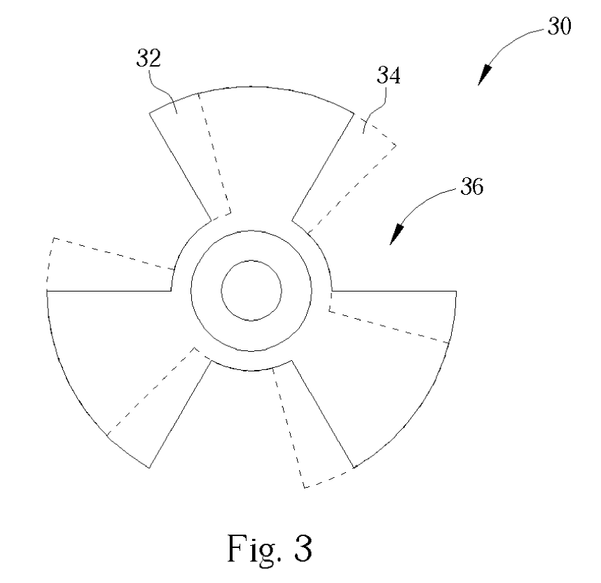

Please refer to FIG. 3, which is a schematic diagram of a shutter device 30 having a variable opening area according to a preferred embodiment of the present invention. The shutter device 30 includes a plurality of triple-blade shutters, which is illustrated with the combination of a first triple-blade shutter 32 and a second triple-blade shutter 34. The first triple-blade shutter 32 and the second triple-blade shutter 34 are installed on the same rotational axis, and a step motor (not shown) is utilized to adjust the relative positions of the first triple-blade shutter 32 and the second triple-blade shutter 34, and change the rotating speed. When fixing the first triple-blade shutter 32 and rotating the second triple-blade shutter 34, the size of the opening area 36 will be changed with the rotating position of the second triple-blade shutter 34. When the first triple-blade shutter 32 and the second triple-blade shutter 34 are overlapped, the size of the opening area 36 is at the biggest status, and the size of the opening area 36 will gradually decrease with rotation of the second triple-blade shutter 34. The smallest status of the opening area 36 depends on the shape and size of the first triple-blade shutter 32 and the second triple-blade shutter 34. The shape and size of the first triple-blade shutter 32 and the second triple-blade shutter 34 can be predetermined according to the requirement to have a best efficiency.

When the required dose is higher and needs longer exposure time, the first triple-blade shutter 32 and the second triple-blade shutter 34 can be controlled to rotate over-lapped. The opening area 36 between the first triple-blade shutter 32 and the second triple-blade shutter 34 is similar to that of using a single triple-blade shutter and has a maximum size. When performing the low-dose process, the relative positions of the first triple-blade shutter 32 and the second triple-blade shutter 34 can be adjusted in advance, and the first triple-blade shutter 32 and the second triple-blade shutter 34 are partially overlapped to reduce the size of the opening area 36. Then, the first triple-blade shutter 32 and the second triple-blade shutter 34 are rotated with these fixed relative positions in the exposure process to lower the dose. Because the first triple-blade shutter 32 and the second triple-blade shutter 34 are driven by the step motor, the relative positions of the first triple-blade shutter 32 and the second triple-blade shutter 34 can be accurately controlled and size of the opening area 36 can be also accurately decided.

With the claimed shutter device 30, the exposure process no longer needs to adjust position of the lamp 12 or insert a filter to reduce the light intensity when changing processes having different doses. The first triple-blade shutter 32 and the second triple-blade shutter 34 are rotated to the predetermined relative positions in accordance with the required dose, and the exposure process is performed with these relative positions. The throughput can be effectively improved, and the process variance caused by the lamp decay can be also controlled by adjusting the opening area 36 in accordance with the light intensity.

For adjusting the relative positions of the first triple-blade shutter 32 and the second triple-blade shutter 34, a manual operation or an automatic operation with programming control can either or both be used. The photolithography system can detect the light intensity of the lamp 12 in advance, and compare the value with the dose required in the exposure process. With this comparison, the size of the opening area 36 can be decided, and the step motor (not shown) will drive the first triple-blade shutter 32 and the second triple-blade shutter 34 rotating to the corresponding relative positions. Finally, the first triple-blade shutter 32 and the second triple-blade shutter 34 are rotated synchronously to perform the exposure process. In addition, the opening area 36 of the shutter device 30 is adjustable and the rotating speed of the shutter device is also controllable, so the required setup of the exposure process can be easily accomplished by controlling size of the opening area 36 and the rotating speed of the shutter device 30. Hence, the claimed shutter device 30 can be utilized in both low-dose and high-dose processes without changing the hardware of the photolithography system.

The above-mentioned embodiment explains the shutter device 30 with the combination of the first triple-blade shutter 32 and the second triple-blade shutter 34, but the present invention is not limited in this application. The present invention can be also achieved by utilizing more than two triple-blade shutters to form a shutter device. In addition, the shutter is not limited in using triple blade structure, and all the structures having an opening area between blades can be combined to achieve the present invention.

In contrast to the prior art, the present invention using the shutter device with variable opening area can be adjusted according to the process requirements so that the shutter device is suitable for both low-dose and high-dose processes without repeatedly changing position of the lamp or replacing the filter. The present invention has the advantages of saving time and improving the throughput. In addition, the present invention can automatically adjust size of the opening area according to the light intensity detected, lowering the process variance and improving the yield.

Those skilled in the art will readily observe that numerous modifications and alterations of the device and method may be made while retaining the teachings of the invention. Accordingly, the above disclosure should be construed as limited only by the metes and bounds of the appended claims.

1. A photolithography system used for a semiconductor process, comprising:
a light source;
a lens set; and
a shutter device having a variable opening area and locating between the light source and the lens set.

2. The photolithography system of claim 1 wherein the shutter device is comprised of a plurality of triple-blade shutters.

3. The photolithography system of claim 2 wherein the shutter device utilizes a step motor to adjust relative positions of the triple-blade shutters.

4. The photolithography system of claim 1 wherein size of the variable opening area is decided in accordance with intensity of the light source.

5. The photolithography system of claim 1 wherein size of the variable opening area is decided in accordance with a dose required in manufacturing process.

6. A photolithography system used for a semiconductor process, comprising:
a light source;
a lens set; and
a shutter device comprising a plurality of triple-blade shutters and locating between the light source and the lens set.

7. The photolithography system of claim 6 wherein the shutter device utilizes a step motor to adjust relative positions of the triple-blade shutters.

8. The photolithography system of claim 6 wherein the shutter device has a variable opening area, and size of the variable opening area is decided in accordance with intensity of the light source.

9. The photolithography system of claim 6 wherein the shutter device has a variable opening area, and size of the variable opening area is decided in accordance with a dose required in manufacturing process.

10. A photolithography method, at least comprising:
providing a shutter device having a variable opening area in a photolithograph system;
adjusting size of the variable opening area in accordance with a dose of an photolithography process; and
performing the photolithography process.

11. The photolithography method of claim 10 wherein the shutter device at least comprises a first triple-blade shutter and a second triple-blade shutter, and the first and second triple-blade shutters are installed on a coaxial position.

12. The photolithography method of claim 11 wherein the step of adjusting size of the variable opening area comprises rotating the second triple-blade shutter to cause the blades of the first and second triple-blade shutters to at least partially overlap.

13. The photolithography method of claim 11 wherein the step of adjusting size of the variable opening area comprises utilizing a step motor to adjust relative positions of the first and second triple-blade shutters.
